(19) United States
(12) Patent Application Publication
(10) Pub. No.: US 2004/0096604 A1
(43) Pub. Date: May 20, 2004

(54) Wound multi-layer tube having one or more embossed plies

(75) Inventor: Johannes W. van de Camp, Hartsville, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sonoco Development, Inc.

(21) Appl. No.: 10/298,409

(22) Filed: Nov. 18, 2002

(51) Int. Cl. B32B 1/08

(52) U.S. Cl. 428/34.2

(57) ABSTRACT

A spirally or convolutely wound multi-layer tube includes one or more plies or layers that have embossments formed therein and projecting from one or both sides of each such ply or layer. The embossments increase the effective caliper and volume of the ply without adding mass. The embossments can abut an adjacent ply or layer of the tube and space such adjacent ply or layer from regions of the embossed ply or layer between the embossments, thereby forming void spaces in the tube wall.

### FIELD OF THE INVENTION

The invention relates to tubes that are produced by winding one or more plies of material about an axis in such a manner that a cylindrical body wall is formed having a plurality of layers making up the radial thickness of the wall.

### BACKGROUND OF THE INVENTION

Spirally wound and convolutely wound tubes are widely used for a variety of purposes. A spirally wound tube is formed by winding a plurality of material plies onto a circular cylindrical mandrel at a given spiral wind angle, the plies being wound one upon another and adhered together to build up a cylindrical multi-layer tube. A convolutely wound tube is formed by wrapping a single material ply about a cylindrical (circular or non-circular) mandrel for a plurality of turns about the mandrel and adhering the various turns together to build up a cylindrical multi-layer tube.

Wound multi-layer tubes are used as winding cores for winding rolls of web materials such as paper, plastic film, sheet metal, textiles, etc. Such tubes are also used as yarn carriers in the production of yarn, as container bodies, and as forms for pouring concrete columns. In many of these applications, certain strength properties of the tubes are important.

In the case of paperboard winding cores, typically a customer specifies required inside and outside diameters of a core, and the core must have certain minimum strength properties to be able to maintain integrity and dimensions in use. At the same time, the core manufacturer desires to minimize the cost of producing the core. The assignee of the present application has developed methods for optimizing various core strength properties while minimizing the use of costly high-grade paperboard, by building cores from multiple grades of paperboard. For instance, it has been found that very good flat crush strength can be achieved in a spirally wound paperboard tube even when some of the plies of the tube comprise lower-grade (and therefore lower-strength) paperboard, as long as the lower-grade plies are properly positioned within the tube wall. The assignee has developed a finite element-based model for analyzing and designing such multi-grade cores to optimize various strength properties such as flat crush, radial crush, axial bending strength, etc.

In some applications, high flat crush or radial crush strength may not be required, and hence even lower-strength plies might be used in building up a tube if such plies were available. However, the paperboard quality range that is available in the market is in some cases too strong to achieve the best financial results.

It is known to include a corrugated ply in a spirally or convolutely wound paperboard tube. The corrugations or ridges of a corrugated ply can remain unbroken during the spiral winding process if they run parallel to the axis of the tube, and hence can retain their longitudinal bending strength. The resulting tube would be weak in torsion, however, because the corrugations of the corrugated ply when subjected to a shear load in the circumferential direction would tend to lay down or collapse; thus, a tube having a corrugated ply whose corrugations run parallel to the tube axis would not be suitable as a winding core where substantial circumferential shear loads can be exerted on the plies.

At first glance, a solution to the problem of poor torsional strength would appear to be to orient the corrugations non-parallel to the tube axis. Unless special steps are taken (such as moistening the corrugated ply, winding the ply while moist, and then drying the ply after winding, as exemplified in U.S. Pat. No. 663,438 to Hinde), however, the corrugations will be bent and may even break as a result of being forced to extend helically, and hence will be weakened considerably. It is known to score such non-parallel corrugations to prevent them from breaking when the ply is wound, but the scoring undermines the strength of the corrugated ply and thus is not a good solution to the problem.

### SUMMARY OF THE INVENTION

The present invention addresses the above needs and achieves other advantages, by taking a wholly different approach to the general objective of reducing the amount of costly high-strength materials in a wound tube. In accordance with the invention, one or more layers of the tube wall are effectively increased in volume without adding any mass by embossing the layer(s). Embossments project from at least one side of the embossed layer so as to increase the effective caliper of the layer. The embossments are spaced apart in two different (e.g., orthogonal) directions of the embossed layer, and consequently they increase the bending stiffness of the layer in the two different directions. In contrast, a corrugated ply is relatively strong in bending in one direction where the bending line runs perpendicular to the corrugations, but is much weaker in bending in the orthogonal direction where the bending line runs parallel to the corrugations. Additionally, an embossed ply can be wound with rows of the embossments running either parallel or non-parallel to the tube axis without weakening the ply in bending.

The embossments can comprise various shapes, including but not limited to truncated cones and truncated pyramids. The embossments can project from only one side or from both sides of the ply. In preferred embodiments comprising paperboard tubes, the embossed ply is embossed while in a wet or moistened state and is then dried prior to incorporating the ply into the tube.

In one embodiment of the invention, a tube is formed of a single ply. The ply is embossed and is wound so that opposite edges of the ply form an overlap joint at which the overlapping edges are adhered together. The enhanced bending stiffness afforded by the embossed ply allows the single-ply tube to have an improved bending stiffness relative to a single-ply tube formed of a non-embossed ply. Such single-ply tubes may be useful as cores for consumer rolls of toilet tissue, paper towels, plastic film, aluminum foil, etc., or as container bodies.

In other embodiments of the invention, a tube is formed of a plurality of plies, including at least one non-embossed layer in addition to the one or more embossed layers. Preferably, each embossed layer is radially adjacent to a non-embossed layer. The embossments abut the adjacent layer, thereby spacing the adjacent layer from regions of the embossed layer that are between the embossments. As a result, void volumes are effectively introduced into the tube wall. The tube wall thus has an increased volume per unit mass relative to an otherwise identical tube that does not include embossments in the intermediate layer(s). Stated differently, for a given tube wall volume, the mass of material making up the wall is reduced, and therefore unit costs can be reduced. Nevertheless, it has been found that certain strength properties of the tube (notably, ID stiffness and/or OD stiffness) can be comparable to those of tubes not having any embossed plies.

The embossments could be depressed and thereby reduced in height as a result of compressive pressures exerted on the embossed ply during the tube forming operation, which would be undesirable because the effective caliper and volume of the ply would be reduced. This tendency can be diminished in spirally wound tubes by winding the embossed ply or plies at a position downstream of the winding belt, and/or by winding the plies at a relatively small spiral wind angle (measured from the tube axis) such that the plies are relatively wide for a given tube diameter. For example, the spiral wind angle can be less than about 55 degrees.

The invention is not limited to paperboard tubes. In one embodiment, a tube is constructed of sheet metal plies, such as aluminum. At least one ply is embossed as noted above. The resulting tube can advantageously be used as a winding core for winding sheet metal of the same material as that used to construct the tube, thus simplifying recycling of the core when scrap wound material still remains on the core because there is no need to remove the scrap wound material and direct the wound material and the core into separate recycling streams; instead, the core with the scrap wound material attached can be directed into a single recycling stream.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a diagrammatic depiction of an apparatus and process for forming a spirally wound tube with an intermediate embossed ply;

FIG. 2 is a fragmentary perspective view of a ply showing truncated cone embossments projecting from one side thereof;

FIG. 2A depicts one possible alternative form of embossment shaped as a truncated pyramid;

FIG. 3 is a cross-sectional view through the ply of FIG. 2;

FIG. 4 is a fragmentary cross-section of a wall of a tube having an embossed ply in accordance with one embodiment of the invention;

FIG. 5 is a cross-sectional view of a ply having embossments projecting from both sides;

FIG. 6 is a diagram showing a preferred process and system for embossing a paperboard ply in accordance with the invention;

FIG. 7 is a view similar to FIG. 4, showing an alternative embodiment of a tube having two embossed plies;

FIG. 8 illustrates winding a relatively wide embossed ply at a relatively low spiral wind angle to reduce the tendency of crushing the embossments;

FIG. 9 schematically illustrates a convolute winding process for forming a multi-layer tube having one or more embossed intermediate layers in accordance with the invention;

FIG. 10 shows an alternative embodiment of a tube in accordance with the invention; and

FIG. 11 shows yet another alternative embodiment of a tube in accordance with the invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

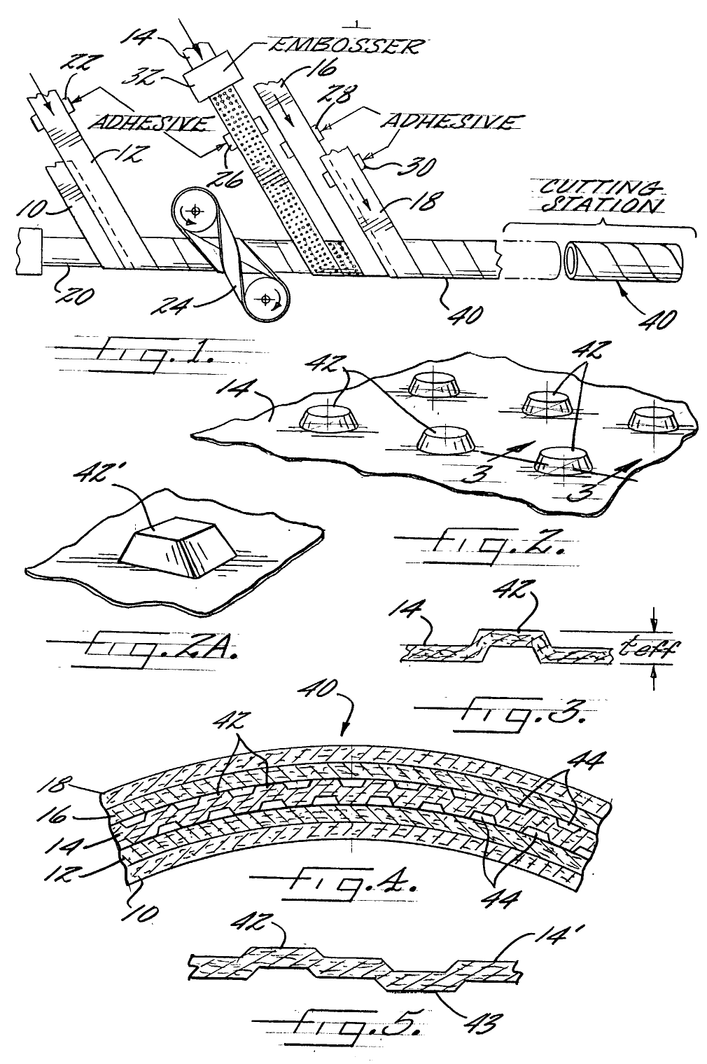

As noted, the invention is based on the principle of increasing the effective caliper and volume of one or more plies or layers in a multi-layer tube by embossing the one or more plies or layers. FIG. 1 shows one exemplary process and apparatus for forming a spirally wound tube in accordance with the invention. The tube is formed by spirally winding a plurality of plies 10, 12, 14, 16, 18 onto an elongate stationary mandrel 20 of circular cylindrical form. Five plies are illustrated, but the invention is applicable to tubes having as few as one and an many as 25 or more plies. Plies 10 and 12 are spirally wound in that order onto the mandrel 20 and adhesive is applied by an adhesive applicator 22 to the inward-facing surface of the second ply 12 to adhere the plies 10 and 12 together to form a tube on the mandrel. A conventional winding belt 24 engages this tube and advances the tube along the mandrel in a screw fashion, which serves to draw the plies 10, 12 and the subsequently wound plies 14, 16, and 18 onto the mandrel or the advancing tube as the case may be. Downstream of the winding belt 24, the plies 14, 16, and 18 are spirally wound onto the advancing tube, and adhesive applicators 26, 28, and 30 respectively apply adhesive to these plies to adhere them to one another and to the ply 12, thus forming an integral tube 40.

In this embodiment, the ply 14 is embossed. FIG. 1 illustrates the ply 14 being passed through an in-line embosser 32 to emboss the ply. Thus, the ply 14 is drawn from a supply roll (not shown) as an ordinary unembossed ply and is embossed in the embosser 32 as the ply is being advanced to the mandrel 20. Alternatively, an embossed ply could be prepared beforehand and could be supplied in the form of a roll of embossed material, such that the embossed ply would simply be drawn from the supply roll and advanced to the mandrel.

FIG. 2 depicts one embodiment of an embossing pattern that can be used in accordance with the invention. The ply 14 in this embodiment includes a plurality of embossments 42 that project from one side of the ply. As used herein, the term “emboss” denotes a process wherein a localized region of the ply is forced to deform into a recess or depression in a surface of a tool such as a die or roller such that the deformation remains after the deforming force is removed; “embossment” denotes the localized deformed region of the ply so made. The embossments 42 are spaced apart in two different directions in the plane of the ply 14.

The embossments 42 in FIG. 2 have the form of truncated cones. FIG. 2A depicts one possible alternative form of embossment 42′ shaped as a truncated pyramid. Embossments of other shapes can also be used.

FIG. 3 shows a cross-sectional view of an embossment 42. The embossment is characterized by a projection on one side of the ply and a corresponding depression or recess in the opposite side of the ply.

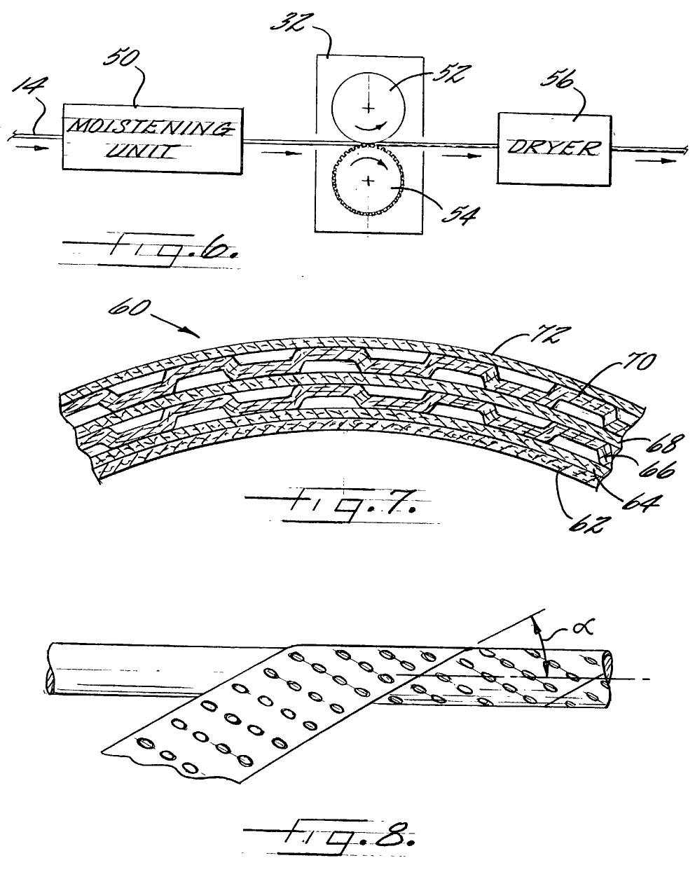

FIG. 4 depicts a cross section of the wall of the tube 40 produced in accordance with the process shown in FIG. 1. The embossments 42 in the intermediate ply 14 abut the adjacent ply 16. When the embossments 42 are spaced sufficiently close to one another, the ply 16 will tend not to deform into the spaces between the embossments but will instead be spaced from the regions of the ply 14 located between the embossments. As a result, void spaces 44 are formed in the tube wall between the plies 14 and 16 and between the embossments. Additionally, void spaces are also formed between the ply 12 and the ply 14 in the regions of the embossments 42 because of the corresponding depressions that exist in the inward-facing surface of the ply 14. Consequently, the effective caliper of the embossed ply 14 is greater than the caliper of the sheet material from which the embossed ply is made. As illustrated in FIG. 3, the effective caliper t_{eff} is essentially measured from the tops of the embossments 42 to the bottom surface of the ply 14 (although when incorporated into the tube, the effective caliper may be reduced somewhat as a result of the embossments being compressed and thereby shortened during the tube winding and forming process, as discussed further below). The effective volume of the embossed ply 14 thus is increased without any increase in mass of the ply.

The embossments can project from both sides of the ply, if desired. FIG. 5 shows an alternative embossed ply 14′ having embossments 42 (only one shown) projecting from one side of the ply and embossments 43 (only one shown) projecting from the opposite side of the ply. This type of embossing pattern may be effective in creating a greater amount of void space within the tube wall, relative to a ply having embossments from only one side.

The invention is applicable to tubes made from various types of materials, including paperboard, sheet metal such as aluminum or steel, and others. In the case of paperboard, embossing a dry paperboard ply could result in significant breakage of fibers in the region of the embossments, which may weaken the ply. Accordingly, it is preferred to emboss a paperboard ply using a process diagrammatically represented in FIG. 6. The ply 14 is first moistened in a moistening unit 50 to loosen the fiber bonds. The moistened ply is passed through an embosser, which may comprise a pair of opposed embossing rolls 52, 54 that form a nip through which the moistened ply is passed. The roll 52 defines a plurality of recesses or depressions in its outer surface, and the roll 54 has a plurality of corresponding projections that are in registration with the depressions in the roll 52 and are configured to deform localized regions of the moistened ply 14 into the depressions in the roll 52. After exiting the embosser, the ply 14 is dried in a dryer 56.

The invention is not limited to tubes having a single embossed ply. FIG. 7 shows an alternative embodiment of a tube 60 having two embossed plies and four unembossed plies. More particularly, the tube wall has a radially inner region made up of two adjacent unembossed plies 62, 64. A radially intermediate region of the tube wall is made up of three plies, which comprise an inner embossed ply 66 that is adjacent the ply 64, a middle unembossed ply 68 immediately outward of and contiguous with the inner embossed ply 66, and an outer embossed ply 70 immediately outward of and contiguous with the ply 68. An outermost unembossed ply 72 is wound about the outer embossed ply 70. Thus, each embossed ply is sandwiched between two unembossed plies.

During a spiral winding process as illustrated for instance in FIG. 1, each ply is subjected to radially inward compression as a result of the winding tension of the ply and the winding tension of plies that are wound on top of the ply; additionally, those plies that are wound onto the mandrel upstream of the winding belt are also subjected to pressure by the winding belt. The radially inward compression of an embossed ply may result in the embossments of the ply being flattened to some extent, thereby reducing the effective caliper and volume of the ply. The compression of the embossed ply or plies can be lessened by winding the embossed ply or plies downstream of the winding belt, as depicted for the embossed ply 14 in FIG. 1.

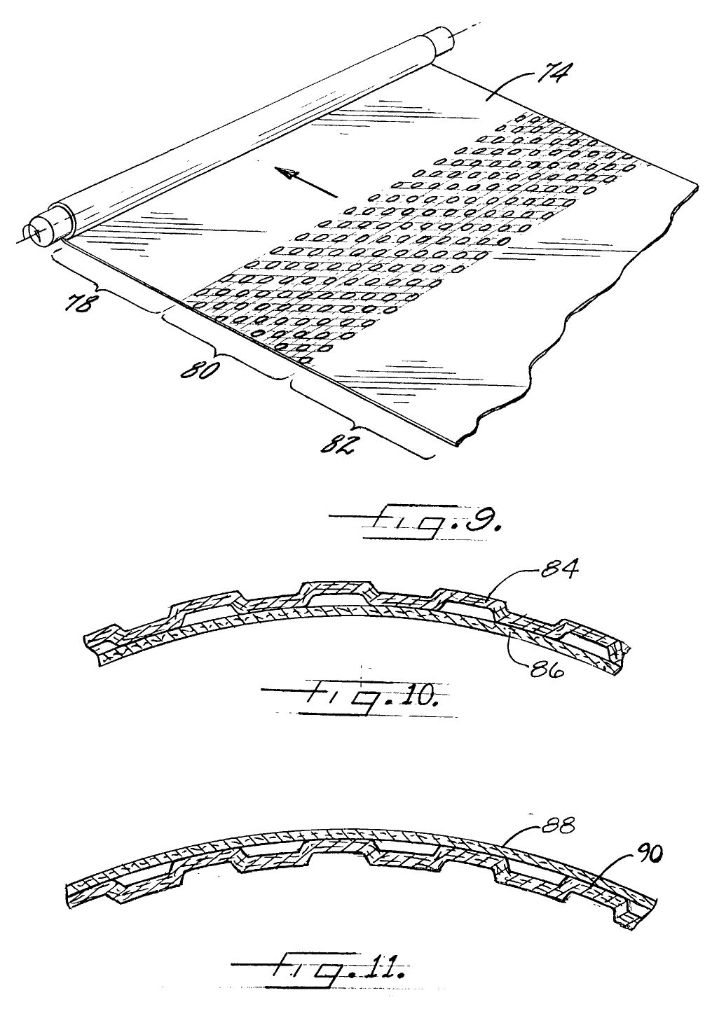

Another technique for reducing the flattening of the embossments during spiral winding is to use plies that are relatively wide and are wound at a relatively small spiral wind angle a (measured from the tube axis), as shown in FIG. 8. In most spiral winding processes, the plies are wound at a spiral wind angle of at least about 45 degrees. In accordance with the invention, a spirally wound tube having one or more embossed plies is formed by winding the plies at a spiral wind angle that is less than about 55 degrees. As a result, for a given tube diameter, the plies are relatively wide; in turn, for a given tube length, the plies wrap about the tube axis a relatively small number of times. This has been found to lead to lower ply compression and hence less tendency to flatten the embossments of the embossed ply or plies.

As noted, the invention is not limited to spirally wound tubes. Multi-layer tubes in accordance with the invention can also be produced by the convolute winding process, wherein a single strip of material having a width corresponding to the desired length of the tube to be produced is wound about a mandrel for a plurality of wraps. To produce a convolutely wound tube having one or more intermediate layers that are embossed, a material strip 74 generally as shown in FIG. 9 is used. The strip has an inner end portion 78 (i.e., a portion that when wound about the mandrel 76 will form a radially inner region of the tube wall) that is not embossed, an intermediate portion 80 that is embossed, and an outer end portion 82 that is not embossed. When the strip 74 is wound about the mandrel, the resulting tube thus has a radially inner region made up of one or more unembossed layers, an intermediate region made up of one or more embossed layers, and a radially outer region made up of one or more unembossed layers.

The invention is not limited to tubes having three or more plies. For instance, FIGS. 10 and 11 show two embodiments of a two-ply paperboard tube. In the embodiment of FIG. 10, an embossed paperboard ply 84 forms an outer surface of the tube and an unembossed paperboard ply 86 forms an inner surface of the tube, and the plies 84 and 86 are adjacent and adhered together. In the embodiment of FIG. 11, the positions of the plies are reversed, such that the outer ply is an unembossed ply 88 and the inner ply is an embossed ply 90.

The invention can even be applied to a one-ply tube. To form a one-ply tube in accordance with the invention, an embossed ply can be spirally wound as shown in FIG. 8, with one edge portion of the ply overlapping an opposite edge portion of the previous turn of the ply on the mandrel. The overlapping edge portions are adhered together to form an overlap joint. Such a one-ply tube may be useful as a core for roll-form consumer products such a toilet tissue, paper towel, plastic film, gift wrap, aluminum foil, wax paper, etc., or as a container body.

An embossed ply in a tube in accordance with the invention advantageously has a ratio of effective caliper (after embossing) to actual caliper (before embossing) of about 1.2 to 4, and more preferably about 1.5 to 2.5.

The invention enables a spirally or convolutely wound tube to be constructed to have specified inside and outside diameters, for example, while effectively using less material than would have to be used if all of the plies or layers of the tube were unembossed. For instance, if the effective caliper of the embossed ply were twice that of an otherwise identical unembossed ply, two unembossed plies would be needed to make up the same total thickness as one embossed ply. The invention can be useful in applications where the outside diameter of the tube must meet a specified value but the strength requirements of the tube are not particularly demanding.

It has been found based on testing, however, that incorporation of one or more embossed plies in a tube does not necessarily detract significantly from all strength properties of the tube. A spirally wound tube having an inner diameter of three inches was prepared from five unembossed plies of paperboard. Three of the plies were relatively strong Grade A board having a caliper of 15 points (0.015 inch, 0.38 mm) and two plies were relatively weak Grade B board having a caliper of 30 points (0.03 inch, 0.76 mm). The tube build-up from ID to OD was 2A/2B/1A. A second tube of identical inner diameter was prepared from three plies of Grade A board each of 15 point caliper and one ply of Grade B board of 30 point caliper that was embossed such that it had an effective caliper prior to winding of about 65 points (0.065 inch, 1.65 mm). The tube build-up from ID to OD was 2A/1B_{embossed}/1A. The embossed ply had embossments on both sides formed generally as truncated pyramids. A flat crush test, a hoop bending stiffness test, a radial crush test, and an ID stiffness test were conducted on each tube. The results are shown in the following table.

| | Body Paper | |
|---|---|---|
| | Embossed | Regular |
| Build-up | | |
| ID | 15# A board | 15# A board |
| | 15# A board | 15# A board |
| | 30# emb. B board | 30# B board |
| OD | 15# A board | 30# B board |
| | | 15# A board |
| Dimensions | | |
| ID, inches | 3.0 | 3.0 |
| Wall, inches | 0.108 | 0.102 |
| Strength | | |
| Flat crush, lbs/4 inches | 27 | 86 |
| Hoop bending resistance, | | |
| lbs for deflection of: | | |
| 0.125 inch | 14.1 | 39.9 |
| 0.250 inch | 22.8 | 72.6 |
| 0.375 inch | 25.2 | 86.4 |
| 0.500 inch | 27.1 | 81.4 |
| Radial crush, psi | 69 | 216 |
| ID Stiffness, psi/0.001 inch | 15.3 | 15.9 |

The results show that the tube having the embossed ply had about one-third the flat crush and radial crush strength of the regular tube of essentially identical dimensions. The bending stiffness of the tube with the embossed ply was also much lower than that of the regular tube. However, the ID stiffnesses of the two tubes were about the same.

In another test, a number of cores were made each having nine wide plies, one of which was embossed. The radial location of the embossed ply within the tube wall was varied to assess the effect of ply location on the caliper reduction of the embossed ply as a result of the compression of the ply during tube formation. When the embossed ply was the third from outermost ply of the tube, very little caliper reduction of the ply was measured. The caliper reduction was greater when the embossed ply was the fifth ply from the outer surface, but was still relatively slight. When the embossed ply was the eighth ply from the outer surface (i.e., the next to innermost ply), the caliper reduction was greatest but was still low.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A winding core comprising:
from one to a plurality of plies wrapped about an axis and adhered together to form a cylindrical body wall in such a manner that the body wall comprises a plurality of layers including at least a radially inner layer, a radially outer layer, and an intermediate layer radially disposed between the inner and outer layers;
wherein the intermediate layer has embossments projecting from at least one side thereof and spaced apart in both axial and circumferential directions of the body wall, the embossments abutting at least one adjacent layer of the body wall so as to radially space said adjacent layer from regions of the intermediate layer located between the embossments, whereby the embossments effectively increase the volume of the body wall without adding mass.

2. The winding core of claim 1, wherein the cylindrical body wall is formed by spirally winding a plurality of plies about the axis one atop another so as to form said plurality of layers, the embossed intermediate layer comprising an embossed ply.

3. The winding core of claim 1, wherein the cylindrical body wall is formed by convolutely winding a single ply about the axis for a plurality of turns so as to form said plurality of layers, the embossed intermediate layer comprising an embossed widthwise portion of said single ply.

4. The winding core of claim 1, wherein the embossments in the intermediate layer are formed generally as truncated cones or pyramids.

5. The winding core of claim 2, wherein the plies comprise paperboard.

6. The winding core of claim 3, wherein the single ply comprises paperboard.

7. The winding core of claim 5, wherein the ply forming the intermediate layer comprises a wet-embossed paperboard ply formed by moistening the ply to loosen fiber bonds in the ply, embossing the ply while moistened, and drying the ply prior to winding.

8. The winding core of claim 2, wherein a plurality of plies are disposed radially inward of the ply forming the intermediate layer.

9. The winding core of claim 2, wherein a plurality of plies are disposed radially outward of the ply forming the intermediate layer.

10. The winding core of claim 2, wherein the cylindrical body wall contains more than one embossed ply.

11. A spirally wound tube, comprising:
a plurality of plies spirally wound about an axis one upon another and adhered together to form a cylindrical body wall;
wherein at least one intermediate ply located in an interior of the cylindrical body wall is embossed to form embossments projecting from at least one surface of the ply, the embossments abutting at least one adjacent ply of the body wall so as to radially space said adjacent ply from regions of the intermediate ply located between the embossments, whereby the embossments effectively increase the volume of the body wall without adding mass.

12. The spirally wound tube of claim 11, wherein the plies comprise paperboard.

13. The spirally wound tube of claim 11, wherein the embossments project from each of the opposite surfaces of the intermediate ply, the embossments abutting adjacent plies on each side of the intermediate ply.

14. The spirally wound tube of claim 11, wherein the embossments comprise truncated cones or pyramids.

15. The spirally wound tube of claim 11, wherein the plies comprise paperboard and the intermediate ply comprises a wet-embossed paperboard ply formed by moistening the ply to loosen fiber bonds in the ply, embossing the ply while moistened, and drying the ply prior to winding.

16. The spirally wound tube of claim 11, wherein the plies are wound at a spiral wind angle less than about 55 degrees measured from the axis.

17. The spirally wound tube of claim 11, wherein there are at least four plies and the number of plies radially inward of the at least one embossed ply is greater than the number of plies radially outward of the at least one embossed ply.

18. A spirally wound tube, comprising:
a single ply spirally wound about an axis such that one edge portion overlaps an opposite edge portion of the ply, the edge portions being adhered together to form an overlap joint such that the ply forms a tube, and wherein the ply is embossed with embossments projecting from at least one surface of the ply, the embossments being spaced apart both axially and circumferentially of the tube, one surface of the embossed ply forming an inner surface of the tube and an opposite surface of the embossed ply forming an outer surface of the tube.

19. A spirally wound tube, comprising:
a plurality of plies wound about an axis one upon another and adhered together to form a tube, wherein the plurality of plies include an embossed ply having embossments that project from at least one surface of the ply and are spaced apart both axially and circumferentially of the tube, and wherein an inner surface of the tube is formed by an unembossed ply.

20. The spirally wound tube of claim 19, wherein the embossed ply has an effective caliper after embossing that is from about 1.2 to about 4 times a caliper of the ply prior to embossing.

21. The spirally wound tube of claim 20, wherein the effective caliper of the embossed ply is about 1.5 to 2.5 times the caliper prior to embossing.

22. A spirally wound tube, comprising:
a plurality of paperboard plies wound about an axis one upon another and adhered together to form a tube, wherein the plurality of plies include an embossed ply having embossments that project from at least one surface of the ply and are spaced apart both axially and circumferentially of the tube, and wherein an inner surface of the tube is formed by the embossed paperboard ply.
